(19) United States
(12) Patent Application Publication
(10) Pub. No.: US 2014/0291538 A1
(43) Pub. Date: Oct. 2, 2014

(54) STEP UP CIRCUIT AND RADIATION METER

(71) Applicant: NIHON DEMPA KOGYO CO., LTD., TOKYO (JP)

(72) Inventors: TOSHIAKI TAKEUCHI, SAITAMA (JP); KUICHI KUBO, SAITAMA (JP); KUNIO HAMAGUCHI, SAITAMA (JP); KOZO ONO, SAITAMA (JP)

(73) Assignee: NIHON DEMPA KOGYO CO., LTD., TOKYO (JP)

(21) Appl. No.: 14/225,452

(22) Filed: Mar. 26, 2014

(30) Foreign Application Priority Data
Mar. 28, 2013 (JP) 2013-068676

(51) Int. Cl. H02M 3/156; G01T 1/185

(52) U.S. Cl. CPC H02M 3/156; G01T 1/185
USPC 250/387; 323/282

(57) ABSTRACT

A step-up circuit includes a transistor configured to perform switching operation in response to a pulse signal input into a base of the transistor, an inductor disposed between a collector of the transistor and a power source, and a basic step-up circuit connected to a connecting point of the collector of the transistor and the inductor. The basic step-up circuit includes: a first diode, a second diode whose anode is connected to a cathode of the first diode, a third diode whose anode is connected to a cathode of the second diode, a first capacitor disposed between the cathode of the first diode and ground, a second capacitor disposed between an anode of the first diode and the cathode of the second diode, and a third capacitor disposed between a cathode of the third diode and the ground.

### CROSS-REFERENCE TO RELATED APPLICATION

This application claims the priority benefits of Japanese application serial no. 2013-068676, filed on Mar. 28, 2013. The entirety of the above-mentioned patent application is hereby incorporated by reference herein and made a part of this specification.

### TECHNICAL FIELD

This disclosure relates to a step-up circuit that steps up an input voltage, and a radiation meter that includes the step-up circuit.

### DESCRIPTION OF THE RELATED ART

Conventionally, a step-up circuit which steps up a voltage by using a plurality of diodes and capacitors, is already known. For example, Japanese Unexamined Patent Application Publication No. H7-264852 (hereinafter referred to as Patent Literature 1) discloses an N-fold voltage rectifier circuit 200 that steps up an input voltage to a voltage N times higher (where N is an integer equal to or more than 2). FIG. 4 is a circuit diagram illustrating a conventional step-up circuit that includes an N-fold voltage rectifier circuit.

The N-fold voltage rectifier circuit 200 includes N number of diodes 201-1 through 201-N, and the diodes 201-1 through 201-N are connected in series one another from the input terminal side of the N-fold voltage rectifier circuit 200. Also, the N-fold voltage rectifier circuit 200 includes a first capacitor 202-1 connected between an anode of the first diode 201-1 and an anode of the third diode 201-3, and a second capacitor 202-2 connected between an anode of the second diode 201-2 and an anode of the fourth diode 201-4. Similarly to this, the N-fold voltage rectifier circuit 200 includes an (N-2)th capacitor 202-(N-2), which is connected between an anode of an (N-2)th diode 201-(N-2) and an anode of the Nth diode 201-N. Also, the N-fold voltage rectifier circuit 200 includes a capacitor 203 disposed between a cathode of the first diode 201-1 and the ground, and a capacitor 204 disposed between a cathode of the Nth diode 201-N and the ground.

In this type of the N-fold voltage rectifier circuit 200, for example, electric energy is stored in the capacitor 203 when the circuit is in the ON-state where an input voltage is higher than a voltage at the cathode of the first diode 201-1, and then the electric energy is released from the capacitor 203 and is stored in the first capacitor 202-1 via the second diode 201-2 when the circuit is switched to the OFF-state where the input voltage is lower than the voltage at the cathode of the first diode 201-1. Similarly to this, the electric energy is stored in a capacitor whose branch number is even when the circuit is in the ON-state, and then the electric energy is released from the capacitor whose branch number is even, and is stored in a capacitor whose branch number is odd when the circuit is switched to the OFF-state. This allows the N-fold voltage rectifier circuit 200 to step-up an input voltage.

Incidentally, the N-fold voltage rectifier circuit 200 described in Patent Literature 1, which is connected to the ground via only two capacitors 203 and 204, disadvantageously has a difficulty to remove high-frequency components generated in the circuit and high-frequency components included in an input signal. The N-fold voltage rectifier circuit 200, therefore, outputs a voltage having a large ripple. For example, when the N-fold voltage rectifier circuit 200 is used in a radiation meter such as a Geiger Counter, the radiation meter unfortunately outputs a radiation detection pulse by accident due to the variation in voltage applied to a Geiger-Müller tube.

A need thus exists for a step-up circuit and a radiation meter which is not susceptible to the drawback mentioned above.

### SUMMARY OF THE INVENTION

A step-up circuit according to the disclosure includes a transistor configured to perform switching operation in response to a pulse signal input into a base of the transistor, an inductor disposed between a collector of the transistor and a power source, and a basic step-up circuit connected to a connecting point of the collector of the transistor and the inductor. The basic step-up circuit includes: a first diode, a second diode whose anode is connected to a cathode of the first diode, a third diode whose anode is connected to a cathode of the second diode, a first capacitor disposed between the cathode of the first diode and ground, a second capacitor disposed between an anode of the first diode and the cathode of the second diode, and a third capacitor disposed between a cathode of the third diode and the ground.

### BRIEF DESCRIPTION OF THE DRAWINGS

The foregoing and additional features and characteristics of this disclosure will become more apparent from the following detailed description considered with reference to the accompanying drawings.

FIG. 1 is a circuit diagram illustrating a configuration of a radiation meter according to a first embodiment.

FIG. 2 is a circuit diagram illustrating a configuration of a radiation meter according to a second embodiment.

FIG. 3 is a circuit diagram illustrating a connection of N number of additional step-up circuits in a step-up circuit of a radiation meter according to a third embodiment.

FIG. 4 is a circuit diagram illustrating a configuration of a conventional step-up circuit.

### DETAILED DESCRIPTION

### Circuit Configuration of Step-Up Circuit 1 According to First Embodiment

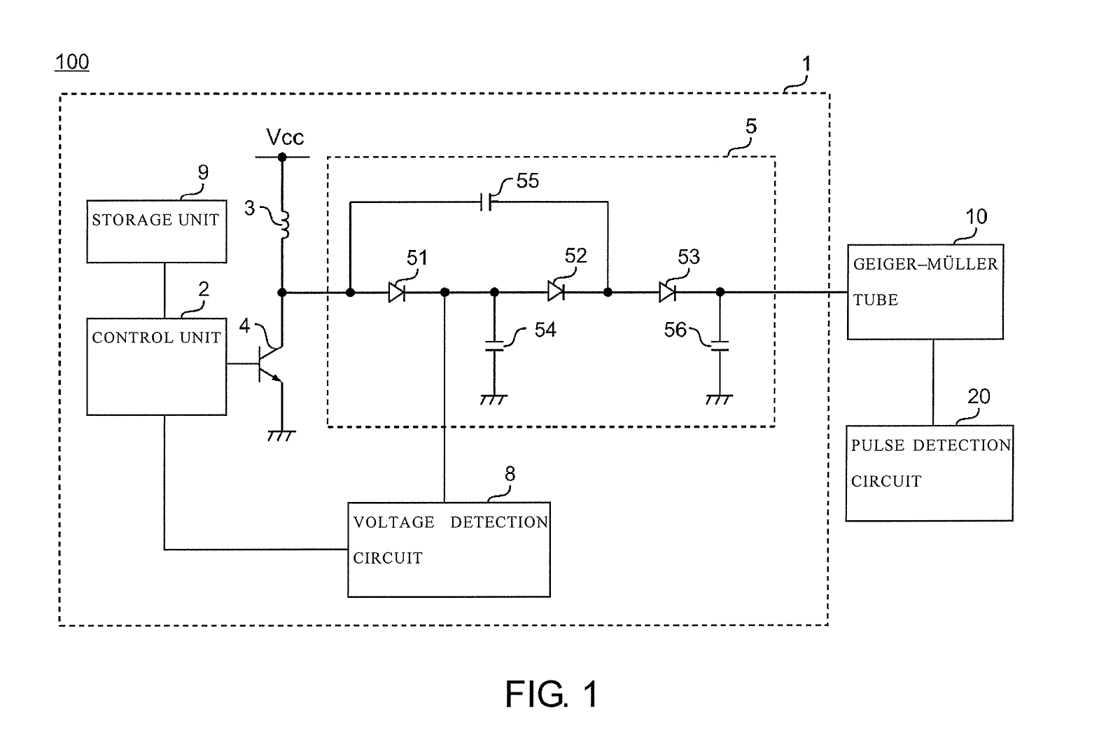

FIG. 1 is a circuit diagram illustrating a configuration of a radiation meter 100 according to a first embodiment. The radiation meter 100 includes a step-up circuit 1, a Geiger-Müller tube 10, and a pulse detection circuit 20.

The step-up circuit 1 includes a control unit 2, an inductor 3, a transistor 4, a basic step-up circuit 5, a voltage detection circuit 8, and a storage unit 9. The step-up circuit 1 is connected to a power source terminal of the Geiger-Müller tube 10. The step-up circuit 1 steps up a voltage of a power source Vcc connected to the inductor 3, and applies the stepped up voltage to the Geiger-Müller tube 10.

The Geiger-Müller tube 10 is connected to the pulse detection circuit 20. The pulse detection circuit 20 detects a pulse of a voltage that is output from the Geiger-Müller tube 10 when radiation particles enter the Geiger-Müller tube 10, and the pulse detection circuit 20 counts the detected pulse.

The control unit 2 is connected to a base of the transistor 4, the voltage detection circuit 8, and the storage unit 9. The control unit 2 controls a pulse width of a pulse signal input into the base of the transistor 4. The inductor 3 is disposed between a collector of the transistor 4 and the power source Vcc.

The base of the transistor 4 is connected to the control unit 2, and then a pulse signal is input into the base of the transistor 4. The collector of the transistor 4 is connected to the inductor 3. An emitter of the transistor 4 is connected to the ground. The transistor 4 performs a switching operation in response to a pulse signal input into the base of the transistor 4, for switching whether or not the collector and the emitter are conductive.

The basic step-up circuit 5 is connected to a connecting point of the collector of the transistor 4 and the inductor 3. The basic step-up circuit 5 steps up the voltage of the power source Vcc, and applies the stepped up voltage to the Geiger-Müller tube 10. The basic step-up circuit 5 includes a first diode 51, a second diode 52, a third diode 53, a first capacitor 54, a second capacitor 55, and a third capacitor 56.

The first diode 51, the second diode 52, and the third diode 53 are connected in series one another. The first diode 51 has an anode connected to the connecting point of the collector of the transistor 4 and the inductor 3, and a cathode connected to an anode of the second diode 52.

The second diode 52 has an anode connected to the cathode of the first diode 51, and a cathode connected to an anode of the third diode 53. The third diode 53 has an anode connected to the cathode of the second diode 52, and a cathode connected to the Geiger-Müller tube 10.

The first capacitor 54 is disposed between the cathode of the first diode 51 and the ground. The second capacitor 55 is disposed between the anode of the first diode 51 and the cathode of the second diode 52. The third capacitor 56 is disposed between the cathode of the third diode 53 and the ground.

The voltage detection circuit 8 is connected to the cathode of the first diode 51 and the control unit 2. The voltage detection circuit 8 detects a voltage stepped up by the basic step-up circuit 5, and outputs the detection result to the control unit 2. The storage unit 9 stores a voltage at the cathode of the first diode 51 as a target voltage. This voltage is determined based on a plateau voltage of the Geiger-Müller tube 10.

The control unit 2 controls the pulse width of the pulse signal to be applied to the base of the transistor 4 in response to the detection voltage detected by the voltage detection circuit 8. Specifically, the control unit 2 determines the pulse width of the pulse signal based on the detection voltage detected by the voltage detection circuit 8 and the target voltage stored in the storage unit 9. Then, the control unit 2 controls the pulse width of the pulse signal to be applied to the base of the transistor 4. For example, the control unit 2 increases the pulse width of the pulse signal when the detection voltage is lower than the target voltage. When the detection voltage is higher than the target voltage, the control unit 2 decreases the pulse width of the pulse

### Operation of Step-Up Circuit 1 According to First Embodiment

The following describes an operation of the step-up circuit 1 according to the first embodiment. First, the control unit 2 applies a pulse voltage to the base of the transistor 4 to make the collector and the emitter of the transistor 4 conductive, which stores magnetic energy in the inductor 3. Subsequently, the control unit 2 stops applying the pulse voltage to make the collector and the emitter of the transistor 4 non-conductive, which releases the magnetic energy from the inductor 3, and stores the released energy into the first capacitor 54 and the third capacitor 56 as electric energy. Note that, the high-frequency components of the magnetic energy released from the inductor 3 flow into the ground respectively via the first capacitor 54 and the third capacitor 56.

With this state, the control unit 2 applies a pulse voltage to the base of the transistor 4 so as to make the collector and the emitter of the transistor 4 conductive, which stores magnetic energy in the inductor 3, as well as releases the electric energy stored in the first capacitor 54, and stores the released electric energy into the second capacitor 55 via the second diode 52. Subsequently, the control unit 2 stops applying the pulse voltage to make the collector and the emitter of the transistor 4 non-conductive, which releases the magnetic energy stored in the inductor 3 as well as releases the electric energy sored in the second capacitor 55. The magnetic energy released from the inductor 3 is stored into the first capacitor 54 and the third capacitor 56 as electric energy. Also, the electric energy released from the second capacitor 55 is stored in the third capacitor 56. The electric energy released from the second capacitor 55 is not stored in the first capacitor 54. Accordingly, a voltage at the cathode of the third diode 53 is higher than a voltage at the cathode of the first diode 51.

### Effect of First Embodiment

As described above, according to the first embodiment, the basic step-up circuit 5 of the step-up circuit 1 includes: the first diode 51, the second diode 52 whose anode is connected to the cathode of the first diode 51, the third diode 53 whose anode is connected to the cathode of the second diode 52, the first capacitor 54 disposed between the cathode of the first diode 51 and the ground, the second capacitor 55 disposed between the anode of the first diode 51 and the cathode of the second diode 52, and the third capacitor 56 disposed between the cathode of the third diode 53 and the ground. This allows making a voltage at the cathode of the third diode 53 higher than a voltage at the cathode of the first diode 51. In addition, this allows the step-up circuit 1 to step-up a voltage with the reduced ripple in the voltage by using the reduced number of components compared with the conventional step-up circuit.

In addition, the control unit 2 controls a pulse width of a pulse signal in response to a detection voltage detected by the voltage detection circuit 8. That is, the control unit 2 determines the pulse width of the pulse signal based on the detection voltage and the target voltage. Accordingly, the step-up circuit 1 can output a voltage corresponding to a specification of the plateau voltage of the Geiger-Müller tube 10.

### Configuration of Radiation Meter 100a According to Second Embodiment

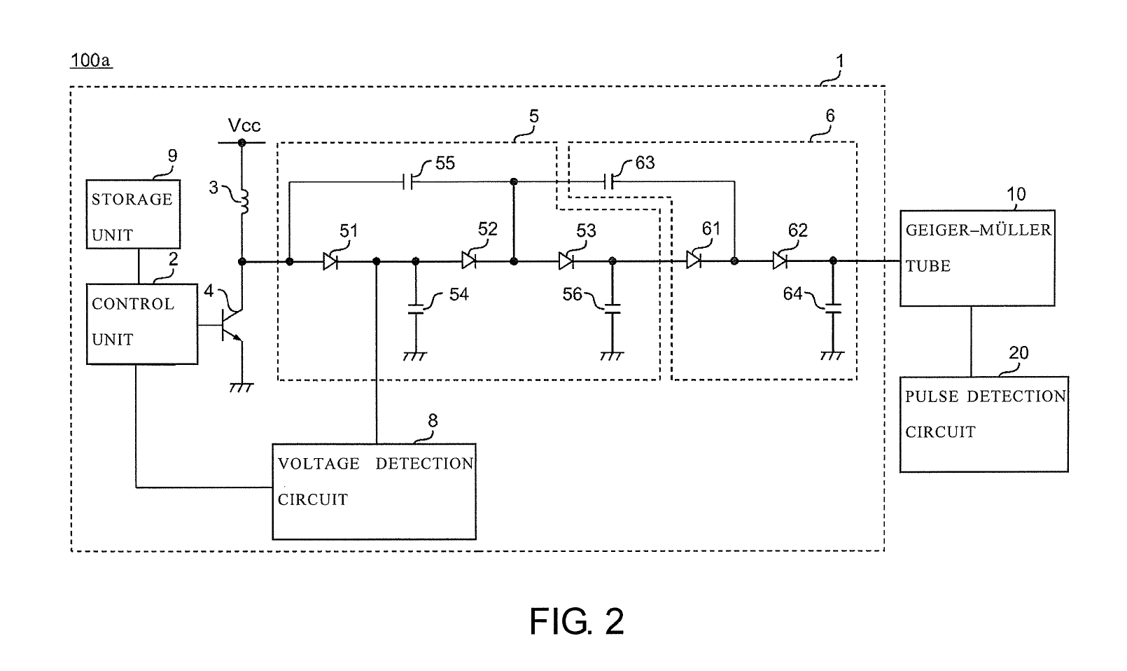

The following describes the second embodiment. FIG. 2 is a circuit diagram illustrating a configuration of a radiation meter 100a according to a second embodiment. The radiation meter 100a according to the second embodiment is different from that of the first embodiment in that the step-up circuit 1 includes an additional step-up circuit 6.

In the second embodiment, the additional step-up circuit 6 is connected to the basic step-up circuit 5 and the Geiger-Müller tube 10 in series. The additional step-up circuit 6 further steps up a voltage which is stepped up by the basic step-up circuit 5, and applies the further stepped up voltage to the Geiger-Müller tube 10. The additional step-up circuit 6 includes a fourth diode 61, a fifth diode 62, a fourth capacitor 63, and a fifth capacitor 64.

The fourth diode 61 and the fifth diode 62 are connected to each other in series. The fourth diode 61 has an anode connected to a cathode of the third diode 53, and a cathode connected to an anode of the fifth diode 62. The fifth diode 62 has the anode connected to the cathode of the fourth diode 61, and a cathode connected to the Geiger-Müller tube 10.

The fourth capacitor 63 is disposed between the anode of the third diode 53 and the cathode of the fourth diode 61. The fifth capacitor 64 is disposed between the cathode of the fifth diode 62 and the ground.

### Operation of Step-Up Circuit 1 According to Second Embodiment

The following describes the operation of the step-up circuit 1 according to the second embodiment. The step up operation by the basic step-up circuit 5 is similar to that of the first embodiment, therefore the description is omitted.

In a state where electric energy is stored in each capacitor of the basic step-up circuit 5, the control unit 2 applies a pulse voltage to a base of the transistor 4 to make a collector and an emitter of the transistor 4 conductive, which stores magnetic energy in the inductor 3. Also, the electric energy stored in the first capacitor 54 is stored into the second capacitor 55 via the second diode 52. Also, the electric energy stored in the third capacitor 56 is stored into the fourth capacitor 63 via the fourth diode 61.

Subsequently, the control unit 2 stops applying the pulse voltage to make the collector and the emitter of the transistor 4 non-conductive, which releases the magnetic energy stored in the inductor 3 as well as releases the electric energy stored in the second capacitor 55 and the fourth capacitor 63. The magnetic energy released from the inductor 3 is stored into the first capacitor 54 as electric energy via the first diode 51.

Also, the electric energy stored in the second capacitor 55 is stored into the third capacitor 56 via the third diode 53. Also, the electric energy stored in the fourth capacitor 63 is stored into the fifth capacitor 64 via the fifth diode 62. This makes a voltage at the cathode of the fifth diode 62 higher than a voltage at the cathode of the third diode 53.

### WORKING EXAMPLE

Subsequently, an experimental result in which the step-up circuit 1 according to the second embodiment stepped up a power source voltage, is described. Each value was set as follows: a voltage of the power source Vcc was 3V, an inductance value of the inductor 3 was 10 mH, and a capacitance value of each capacitor was 1000 pF. Then, the control unit 2 inputs a pulse signal into the transistor 4. As a result, a voltage at the cathode of the first diode 51 was 147V, a voltage at the cathode of the second diode 52 was 162V, a voltage at the cathode of the third diode 53 was 297V, a voltage at the cathode of the fourth diode 61 was 300V, and a voltage at the cathode of the fifth diode 62 was 415V. In addition, the maximum value of a ripple voltage at the cathode of the fifth diode 62 was about 220 mV.

### COMPARATIVE EXAMPLE

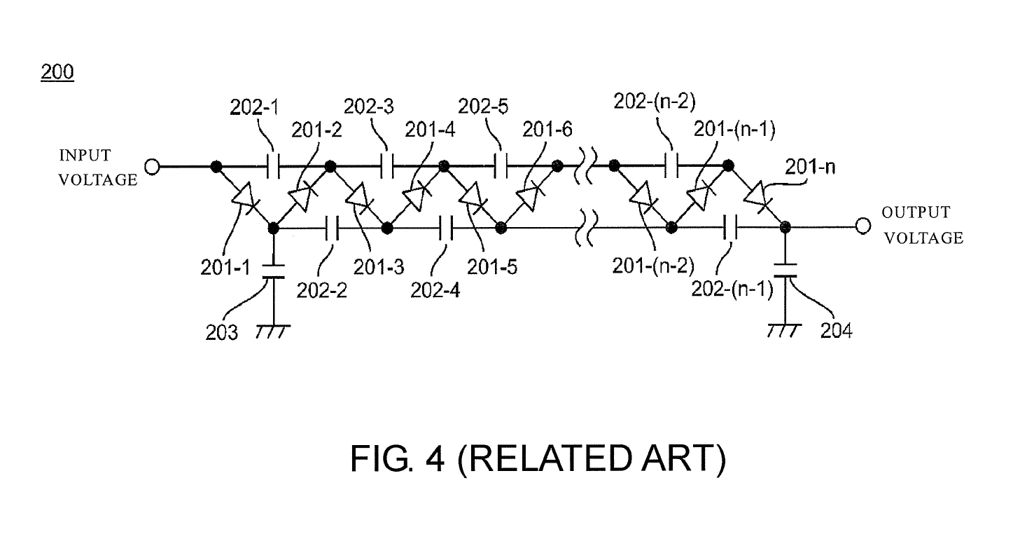

Subsequently, an experiment was carried out in which a ripple voltage was measured in the step-up circuit shown in FIG. 4 in a state where five diodes were connected in the step-up circuit, similarly to the circuit shown in FIG. 2. In this case, the maximum value of the ripple voltage at the output terminal of the step-up circuit was about 1300 mV, which is higher than the maximum value of the ripple voltage of the above-described working example. This result proves that the step-up circuit according to this disclosure can reduce a ripple in voltage compared with the conventional step-up circuit.

### Effect of Second Embodiment

As described above, according to the second embodiment, the additional step-up circuit 6 of the step-up circuit 1 includes: the fourth diode 61 whose anode is connected to the cathode of the third diode 53, the fifth diode 62 whose anode is connected to the cathode of the fourth diode 61, the fourth capacitor 63 disposed between the anode of the third diode 53 and the cathode of the fourth diode 61, and the fifth capacitor 64 disposed between the cathode of the fifth diode 62 and the ground. This allows the step-up circuit 1 to further step-up a voltage that has been stepped up by the basic step-up circuit 5, while removing high-frequency components included in electric energy converted from magnetic energy released from the inductor 3, so as to reduce a ripple in a voltage.

### Circuit Configuration of Step-Up Circuit 1 According to Third Embodiment

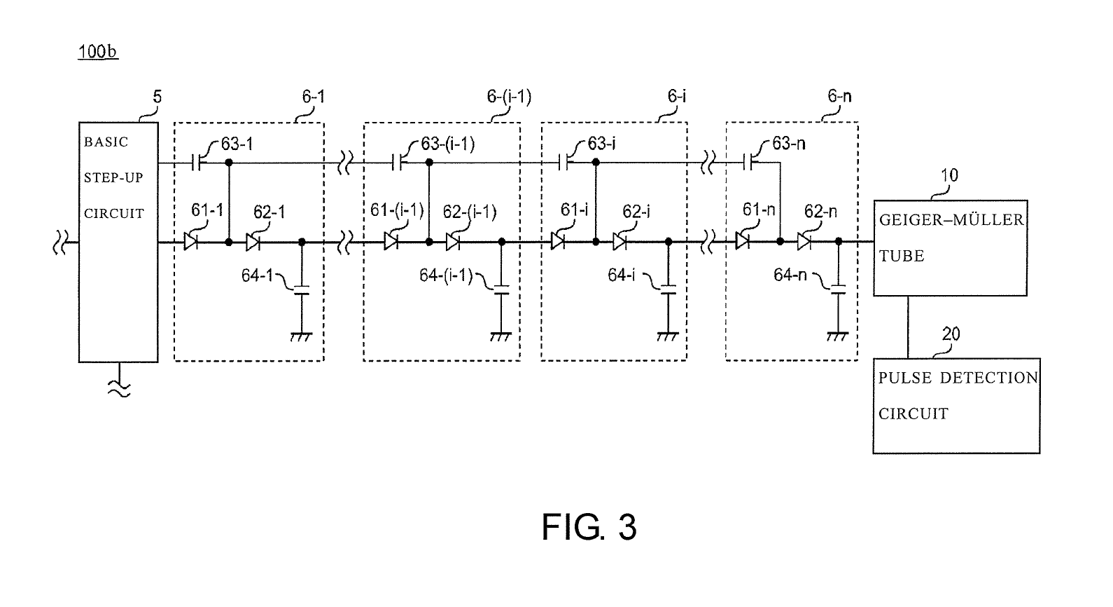

The following describes a third embodiment. A radiation meter 100b according to the third embodiment is different from that of the second embodiment in that the step-up circuit 1 includes N number of additional step-up circuits 6 (where N is an integer equal to or more than 2). FIG. 3 is a circuit diagram illustrating a connection of N number of the additional step-up circuits 6 (additional step-up circuit 6-1 through additional step-up circuit 6-N) in the step-up circuit 1 according to the third embodiment. Hereinafter, N number of the additional step-up circuits 6, namely, the additional step-up circuit 6-1 through the additional step-up circuit 6-(N-1), and the additional step-up circuit 6-N are also referred as to additional step-up circuits 6.

In the third embodiment, the N number of the additional step-up circuits 6 are connected to the basic step-up circuit 5 in series. The N number of the additional step-up circuits 6 are connected to one another in series. The fourth diode 61-i in the ith additional step-up circuit 6-i (where “i” is any integer equal to or more than 2, and equal to or less than “N”) has an anode connected to a cathode of the fifth diode 62-(i−1) in the (i−1)th additional step-up circuit 6-(i−1), and a cathode connected to an anode of the fifth diode 62-i in the ith additional step-up circuit 6-i. The fifth diode 62-i in the ith additional step-up circuit 6-i has the anode connected to the cathode of the fourth diode 61-i in the ith additional step-up circuit 6-i. Also, the fifth diode 62-i in the ith additional step-up circuit 6-i has a cathode connected to an anode of the fourth diode 61-(i+1) in the (i+1)th additional step-up circuit 6-(i+1) when i<N. Alternatively, the cathode of the fifth diode 62-i is connected to the Geiger-Müller tube 10 when i=N.

The fourth capacitor 63-i in the ith additional step-up circuit 6-i is disposed between the anode of the fifth diode 62-(i−1) in the (i−1)th additional step-up circuit 6-(i−1) and the cathode of the fourth diode 61-i in the ith additional step-up circuit 6-i. The fifth capacitor 64-i in the ith additional step-up circuit 6-i is disposed between the cathode of the fifth diode 62-i in the ith additional step-up circuit 6-i and the ground.

### Operation of Step-Up Circuit 1 According to Third Embodiment

The following describes the operation of the step-up circuit 1 according to the third embodiment. Step up operation by the basic step-up circuit 5 is similar to that of the first embodiment and the second embodiment, therefore the description is omitted.

In a state where electric energy is stored in each capacitor of the basic step-up circuit 5, the control unit 2 applies a pulse voltage to a base of the transistor 4 to make a collector and an emitter of the transistor 4 conductive, which releases the electric energy stored in the fifth capacitor 64-(i−1) in the (i−1)th additional step-up circuit 6-(i−1) and stores the released electric energy into the fourth capacitor 63-i in the ith additional step-up circuit 6-i.

Subsequently, the control unit 2 stops applying the pulse voltage to make the collector and the emitter of the transistor non-conductive, which releases the electric energy stored in the fourth capacitor 63-i in the ith additional step-up circuit 6-i. Thus, the electric energy stored in the fourth capacitor 63-i is stored into the fifth capacitor 64-i in the ith additional step-up circuit 6-i. This makes a voltage at the cathode of the fifth diode 62-i in the ith additional step-up circuit 6-i higher than a voltage at the cathode of the fifth diode 62-(i−1) in the (i−1)th additional step-up circuit 6-(i−1).

### Effect of Third Embodiment

As described above, according to the third embodiment, the step-up circuit 1 includes N number of the additional step-up circuits 6 with a multi-stage configuration. Accordingly the step-up circuit 1 can further step-up a voltage stepped up by the basic step-up circuit 5.

Above all, although this disclosure is described with reference to the embodiments, the technical scope of the disclosure is not limited to the scope of the above-described embodiment. It is apparent to those skilled in the art that various variations and modifications can be made to the above-described embodiments.

The above-described step-up circuit further includes an additional step-up circuit connected to the basic step-up circuit in series. The additional step-up circuit may include: a fourth diode whose anode is connected to the cathode of the third diode, a fifth diode whose anode is connected to a cathode of the fourth diode, a fourth capacitor disposed between the anode of the third diode and the cathode of the fourth diode, and a fifth capacitor disposed between a cathode of the fifth diode and the ground.

The above-described step-up circuit may further include N number (where N is an integer equal to or more than 2) of the additional step-up circuits connected to the basic step-up circuit in series. The anode of the fourth diode in an Nth additional step-up circuit may be connected to the cathode of the fifth diode in an (N−1)th additional step-up circuit, and the anode of the fifth diode in the Nth additional step-up circuit may be connected to the cathode of the fourth diode in the Nth additional step-up circuit, and the fourth capacitor in the Nth additional step-up circuit may be disposed between the anode of the fifth diode in the (N−1)th additional step-up circuit and the cathode of the fourth diode in the Nth additional step-up circuit, and the fifth capacitor in the Nth additional step-up circuit may be disposed between the cathode of the fifth diode in the Nth additional step-up circuit and the ground.

The above-described step-up circuit may further include a voltage detection circuit configured to detect a voltage generated by the basic step-up circuit, and a control unit configured to control a pulse width of the pulse signal in response to a detection voltage detected by the voltage detection circuit. In addition, the above-described step-up circuit applies a stepped up voltage to a Geiger-Müller tube, and further includes a storage unit configured to store a target voltage determined based on a plateau voltage of the Geiger-Müller tube. The control unit may determine the pulse width based on the detection voltage and the target voltage, and may generate the pulse signal having the determined pulse width.

A second aspect of this disclosure provides a radiation meter that includes: a Geiger-Müller tube configured to output a pulse voltage corresponding to an input radiation; and the step-up circuit configured to apply a voltage to the Geiger-Müller tube.

The step-up circuit according to this disclosure successfully steps up a voltage with a reduced ripple in voltage.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A step-up circuit, comprising:
a transistor, configured to perform a switching operation in response to a pulse signal input into a base of the transistor;
an inductor, disposed between a collector of the transistor and a power source; and
a basic step-up circuit, connected to a connecting point of the collector of the transistor and the inductor;
wherein the basic step-up circuit includes:
a first diode;
a second diode, whose anode is connected to a cathode of the first diode;
a third diode, whose anode is connected to a cathode of the second diode;
a first capacitor, disposed between the cathode of the first diode and a ground;
a second capacitor, disposed between an anode of the first diode and the cathode of the second diode; and
a third capacitor, disposed between a cathode of the third diode and the ground.

2. The step-up circuit according to claim 1, further comprising:
an additional step-up circuit, connected to the basic step-up circuit in series, wherein the additional step-up circuit includes:
a fourth diode, whose anode is connected to the cathode of the third diode;
a fifth diode, whose anode is connected to a cathode of the fourth diode;
a fourth capacitor, disposed between the anode of the third diode and the cathode of the fourth diode; and
a fifth capacitor, disposed between a cathode of the fifth diode and the ground.

3. The step-up circuit according to claim 2, further comprising:
N number of the additional step-up circuits, connected to the basic step-up circuit in series where N is an integer equal to or more than 2,
wherein the anode of the fourth diode in an Nth additional step-up circuit is connected to the cathode of the fifth diode in an (N-1)th additional step-up circuit,
the anode of the fifth diode in the Nth additional step-up circuit is connected to the cathode of the fourth diode in the Nth additional step-up circuit,
the fourth capacitor in the Nth additional step-up circuit is disposed between the anode of the fifth diode in the (N-1)th additional step-up circuit and the cathode of the fourth diode in the Nth additional step-up circuit, and
the fifth capacitor in the Nth additional step-up circuit is disposed between the cathode of the fifth diode in the Nth additional step-up circuit and the ground.

4. The step-up circuit according to claim 1, further comprising:
a voltage detection circuit, configured to detect a voltage generated by the basic step-up circuit; and
a control unit, configured to control a pulse width of the pulse signal in response to a detection voltage detected by the voltage detection circuit.

5. The step-up circuit according to claim 4,
wherein the step-up circuit applies a stepped up voltage to a Geiger-Müller tube,
the step-up circuit further includes: a storage unit, configured to store a target voltage determined based on a plateau voltage of the Geiger-Müller tube, and
the control unit determines the pulse width based on the detection voltage and the target voltage, and generates the pulse signal having the determined pulse width.

6. A radiation meter, comprising:
a Geiger-Müller tube, configured to output a pulse voltage corresponding to an input radiation; and,
the step-up circuit according to claim 1, the step-up circuit being configured to apply a voltage to the Geiger-Müller tube.
